(19) United States
(12) Patent Application Publication
(10) Pub. No.: US 2009/0225070 A1
(43) Pub. Date: Sep. 10, 2009

(54) Plasma Display Device

(76) Inventors: Makoto Onozawa, Miyazaki (JP); Tomokatsu Kishi, Miyazaki (JP); Katsumi Itoh, Miyazaki (JP); Isao Furukawa, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/720,941

(22) PCT Filed: Aug. 4, 2005
(86) PCT No.: PCT/JP05/14349

§ 371 Date: Jun. 6, 2007

(51) Int. Cl. G09G 3/28; G09G 5/00

(52) U.S. Cl. 345/214; 345/60

(57) ABSTRACT

Provided is a plasma display device for controlling the power voltage of a pre-drive circuit in a manner to correspond to the change in a display percentage. The plasma display device is characterized in that the display percentage of a display screen is detected from a signal inputted, so that the amplitude of a drive pulse to be fed to a sustain output element is controlled on the basis of the display percentage, and in that a sustain current to flow for a sustain period is detected by a sustain current detection circuit so that the amplitude of a drive pulse to be fed to the sustain output element is controlled on the basis of the detection result.

### TECHNICAL FIELD

The present invention relates to a plasma display device. To be more precise, preferred embodiments of the present invention provide a plasma display device for controlling power supply voltage of pre-drive circuit correspondingly to change in a display percentage.

### BACKGROUND ART

Conventionally, in the technological field of a plasma display device, there are known devices of an Alternate Lighting of Surfaces method (hereinafter, abbreviated as ALIS) of adjacently placing multiple first and second electrodes and forming display lines among all the electrodes.

A plasma display panel of the ALIS method performs a so-called interlaced scan. The interlaced scan adjacently and alternately places n (512 for instance) odd-numbered electrodes and even-numbered electrodes of Y electrodes (first electrodes) and n+1 pieces of odd-numbered electrodes and even-numbered electrodes of X electrodes (second electrodes) and performs display emission among all display electrodes (X and Y electrodes) so as to perform display dividedly timewise between even-numbered lines and odd-numbered lines by forming 2n display lines with 2n+1 display electrodes.

FIG. 6 is a diagram showing an overview of a drive circuit of a conventional plasma display panel of the ALIS method. The X electrodes and Y electrodes are alternately placed in parallel, and address electrodes are placed in a vertical direction thereto. Reference character Y1 denotes an odd-numbered Y electrode, Y2 denotes an even-numbered Y electrode, X1 denotes an odd-numbered X electrode, and X2 denotes an even-numbered X electrode. The Y electrodes are connected to a scan driver SD. The scan driver SD is provided with a switch SW, which is switched to sequentially apply scan pulses in an address period. In a sustained discharge period, an odd-numbered Y electrode Y1 is connected to a first Y sustain pulse generating circuit, and an even-numbered Y electrode Y2 is connected to a second Y sustain pulse generating circuit. An odd-numbered X electrode X1 is connected to a first X sustain pulse generating circuit, and an even-numbered X electrode X2 is connected to a second X sustain pulse generating circuit. The address electrodes are connected to an address driver.

In general, amplitude of a drive pulse for driving output elements of a sustain circuit (sustaining voltage circuit) of the plasma display device is constant.

FIG. 7 shows a conventional example of the sustain circuit of the plasma display device.

In FIG. 7, reference character PD1 denotes a pre-drive circuit 1 which forms the drive pulse for driving the output elements of the sustain circuit. PD1 forms the drive pulse for driving output elements Q1 to Q4 based on inputted signals IN1 to IN4.

Reference character Vd denotes a power supply voltage of PD1. In the conventional example, Vd was a constant voltage irrespective of a display percentage of a displayed screen.

As for a scan circuit (scanning circuit) as another conventional technique, there is a method reported in IDM'04 PDP 3-3 (Fuji Electric Co., Ltd.), wherein a gate-collector capacity of an IGBT (Insulated Gate Bipolar Transistor) element in a scan IC is utilized to increase a gate voltage when a current is passing through the IGBT.

Patent Document 1 discloses an invention wherein an nMOS transistor switch is used for an AC-driven plasma display panel driver, and a slave switch circuit responds to a binary control signal to set the gate voltage of the nMOS transistor switch at a source voltage or a voltage higher than the source voltage by a predetermined voltage so that, even if a sustaining/write voltage fluctuates, a malfunction of the nMOS transistor switch is prevented and so a write pulse is accurately generated.

Patent Document 1: Japanese Patent Laid-Open Publication No. 5-265396

In the case where the amplitude of the drive pulse for driving the output elements of the sustain circuit of the plasma display device is constant, there is a possibility that more than necessary drive pulses may be supplied to the output elements when the display percentage (ratio of a display area to the entire screen area on the plasma display screen) is small and a sustain current is small.

In general, the plasma display device increases the number of sustain pulses constituting each subframe in order to heighten peak luminance when the display percentage is small. Therefore, there is a problem of increase in power consumption due to the supply of drive pulses of more than necessary amplitude to the output elements.

In the case where the amplitude of the drive pulse is adjusted to minimize the power consumption of the pre-drive circuit 1 when the display percentage is small and the sustain current is small, then the amplitude of the drive pulse becomes insufficient when the display percentage is large and the sustain current is large. Thus, there is a high possibility that conduction resistance of the output elements cannot be low enough and an operation margin of the plasma display panel may become small with flicker or the like generated in screen.

In the case where the conduction resistance of the output elements is high, voltage drops are large when the sustain current passes so that there is an increase in a minimum value of normally displayable power supply voltage of the sustain circuit. As a result of this, there is a possibility that, when the display percentage is large and the sustain current is large, the voltage may become equal to or lower than a normal display voltage and normal discharge may not be performed at some locations.

In comparison to this, the method reported in IDM'04 PDP 3-3 (Fuji Electric Co., Ltd.) is considered as a means for changing the amplitude of the drive pulse according to size of an output current. In the case of using the method for the sustain circuit of the plasma display device, however, the gate-collector capacity must be increased. Therefore, there is a possibility that the power consumption of the circuit for driving the gate may rise. There is also a possibility that a noise component generated on an output terminal (collector terminal) may be superimposed on the gate voltage and the output elements may malfunction.

An object of the present invention is to provide a plasma display device which can supply optimal amplitude of the drive pulse according to the display percentage to the output elements of the sustain circuit without increasing the gate-collector capacity.

### DISCLOSURE OF THE INVENTION

A plasma display device of the present invention is characterized by detecting a display percentage of a display screen from an inputted signal and controlling amplitude of a drive pulse to be supplied to sustain output elements.

The plasma display device of the present invention is also characterized by detecting a sustain current passing in a sustain period with a sustain current detection circuit and controlling the amplitude of the drive pulse to be supplied to the sustain output elements based on a detection result thereof.

When the display percentage is large and the sustain current is large, the present invention can reduce on resistance of the output elements and secure an operation margin of the plasma display. Conversely, when the display percentage is small and the sustain current is small, it can reduce the amplitude of the drive pulse and decrease power consumption of a pre-drive circuit 1.

It is possible, by using the present invention, to supply the drive pulse of optimal amplitude according to the display percentage to the output elements of the sustain circuit without increasing gate-collector capacity. Even in the case of controlling the drive pulse, it is possible to prevent increase in the power consumption and a malfunction due to noise which could occur in the case of using the conventional circuit (IDM+04 PDP 3-3 (Fuji Electric Co., Ltd.)).

### BRIEF DESCRIPTION OF THE DRAWINGS

FIG. 1 is a diagram showing a first embodiment of a sustain circuit of a plasma display device according to the present invention;

FIG. 2 is a diagram showing a concrete example 1 of a drive power supply voltage drive circuit according to the first embodiment of the present invention;

FIG. 3 is a diagram showing a concrete example 2 of the drive power supply voltage drive circuit according to the first embodiment of the present invention;

FIG. 4 is a diagram showing a second embodiment of the sustain circuit of the plasma display device according to the present invention;

FIG. 5 is a diagram showing a third embodiment of the sustain circuit of the plasma display device according to the present invention;

FIG. 6 is a diagram showing an overview of an ALIS method for a conventional example of a drive circuit of a plasma display panel; and

FIG. 7 is a diagram showing a conventional example of the sustain circuit of the plasma display device.

### DESCRIPTION OF SYMBOLS

1 Pre-drive circuit
2 Drive voltage control circuit
3 Display percentage detection circuit

### BEST MODE FOR CARRYING OUT THE INVENTION

Hereunder, embodiments of the present invention will be described by using the drawings.

### First Embodiment

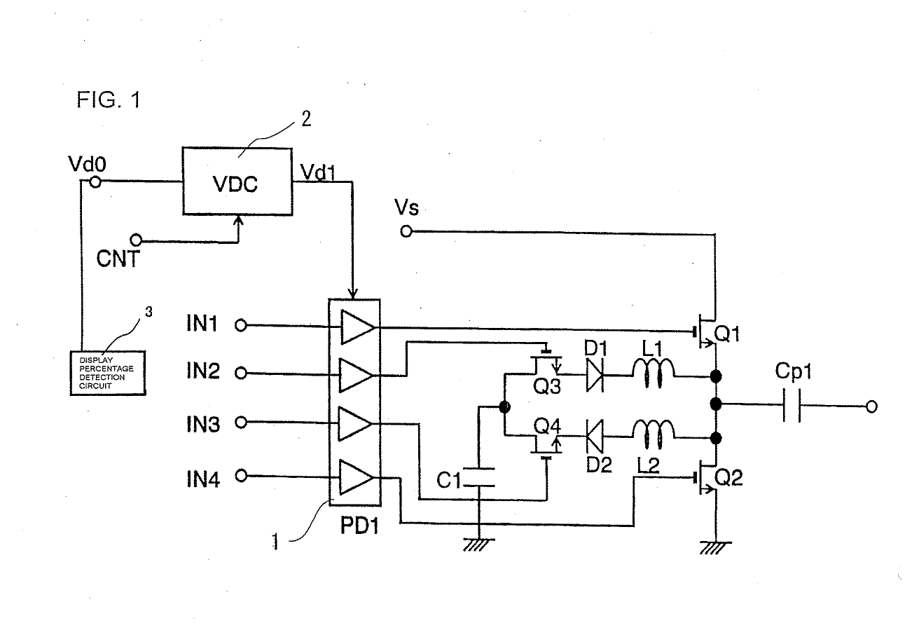

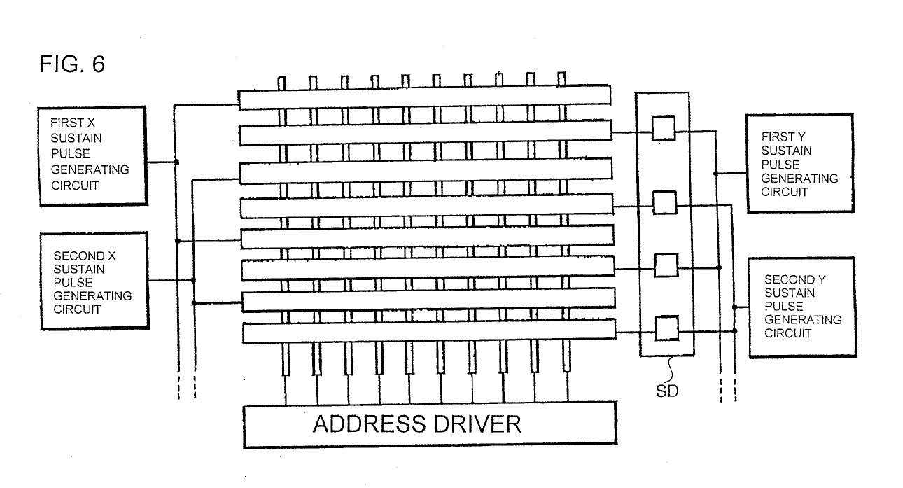

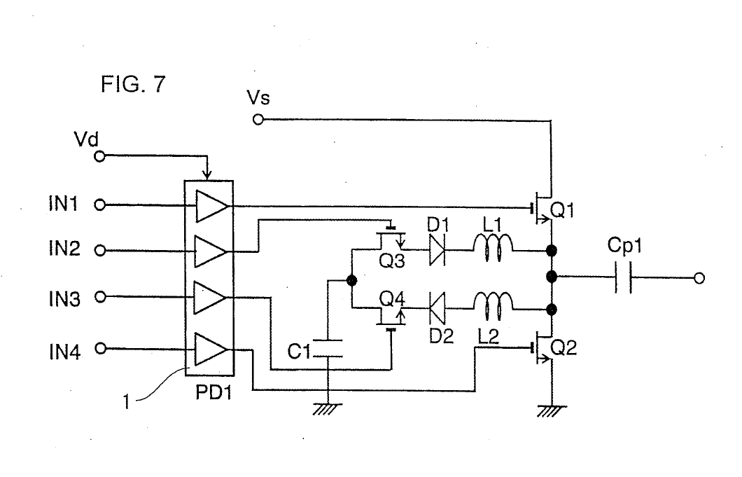

FIG. 1 shows a first embodiment of a sustain circuit of a plasma display device according to the present invention including a plasma display panel shown in FIG. 6 for instance.

In FIG. 1, reference character PD1 denotes a pre-drive circuit which forms a drive pulse for driving output elements of a sustain circuit. PD1 forms the drive pulse for driving output elements Q1 to Q4 based on inputted signals IN1 to IN4.

Reference character VDC2 of FIG. 1 denotes a drive voltage control circuit, which controls a power supply voltage vd1 of a pre-drive circuit 1 based on a control voltage CNT and is supplied with a display percentage of the plasma display device detected by a display percentage detection circuit 3.

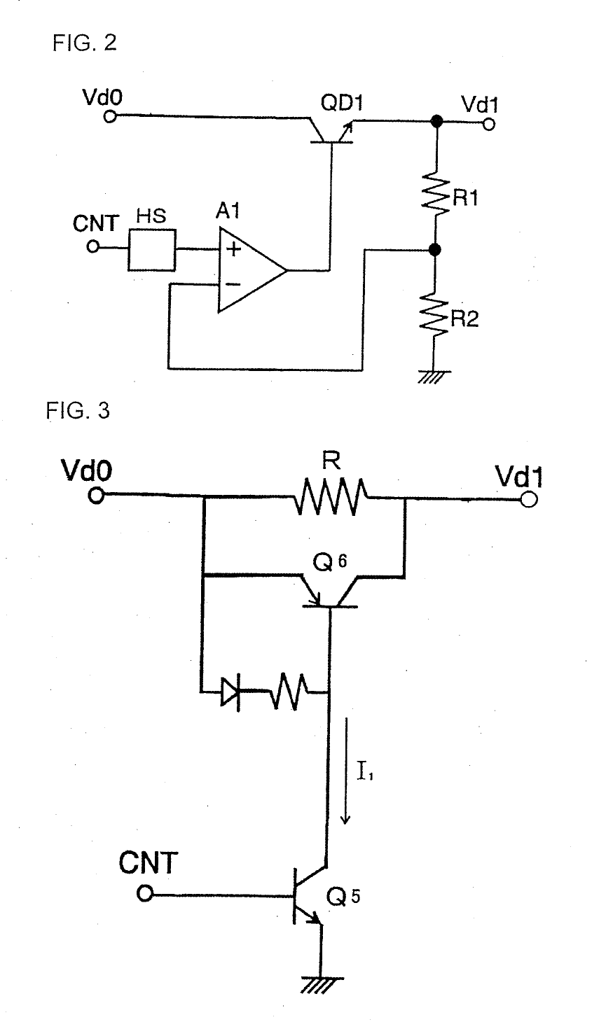

FIG. 2 shows a concrete example of a drive voltage control circuit 2 described in FIG. 1.

In FIG. 2, reference character QD1 denotes a transistor, A1 denotes a differential amplifier circuit, and R1 and R2 denote resistances. The resistances R1 and R2 detect an output voltage Vd1 and input a detection result thereof to A1. The differential amplifier circuit A1 changes a base voltage of the transistor QD1 and controls the output voltage Vd1 based on the control voltage CNT inputted to the differential amplifier circuit A1.

As for the drive voltage control circuit 2 of FIG. 2, it is desirable to insert a hysteresis circuit HS between the control voltage CNT and the differential amplifier circuit A1 in order to alleviate a bump generated at a boundary when switching the control voltage CNT according to fluctuation of the display percentage.

The drive voltage control circuit 2 described in FIG. 2 can control the power supply voltage Vd1 of the pre-drive circuit 1 correspondingly to change in the display percentage by using an output signal of the display percentage detection circuit for detecting the display percentage of a screen from an input video signal as the control voltage CNT.

To be more specific, the sustain circuit of the plasma display device shown in FIG. 1 can increase amplitude of the drive pulse to be supplied to output elements Q1 to Q4 by using the drive voltage control circuit VDC2 when the display percentage is high. As a result of this, it is possible to render a conduction voltage of the output elements Q1 to Q4 smaller.

When the display percentage is low, it is possible to minimize the power consumption of the pre-drive circuit 1 by reducing the amplitude of the drive pulse and setting Q1 to Q4 at the minimum necessary amplitude for driving.

It is possible, by controlling the amplitude of the drive pulse according to the display percentage, to supply optimal amplitude of the drive pulse according to the display percentage to the output elements of the sustain circuit. Thus, it is possible to strike a balance between enlargement of an operation margin at a high display percentage (to further reduce a minimum value of a sustain power supply voltage capable of normal display) and reduction in the power consumption of the pre-drive circuit 1 at a low display percentage.

In the case of using the present invention, it is possible to prevent increase in the power consumption and a malfunction due to noise which could occur in the case of using the conventional circuit (IDM'04 PDP 3-3 (Fuji Electric Co., Ltd.)).

FIG. 3 shows another concrete example of the drive voltage control circuit 2 described in FIG. 1.

In the drive voltage control circuit 2 described in FIG. 3, reference characters Q5 and Q6 denote transistors constituting a current mirror circuit, which can control a gate voltage according to a current.

The drive voltage control circuit 2 of FIG. 3 uses an output signal of the display percentage detection circuit for detecting the display percentage of a screen from an input video signal as the control voltage CNT.

The control voltage CNT is thereby inputted. When the display percentage is large, the transistor Q5 becomes on and the transistor Q6 becomes. on so that the power supply voltage Vd1 becomes large. And when the display percentage is small, the transistor Q5 becomes on and the transistor Q6 becomes off so that the power supply voltage Vd1 becomes small.

The sustain circuit of the plasma display device shown in FIG. 1 can increase amplitude of the drive pulse to be supplied to the output elements Q1 to Q4 by using the drive voltage control circuit VDC2 when the display percentage is high. As a result of this, it is possible to reduce conduction voltage of the output elements Q1 to Q4.

When the display percentage is low, it is possible to minimize the power consumption of the pre-drive circuit 1 by reducing the amplitude of the drive pulse and setting Q1 to Q4 at the minimum necessary amplitude for driving.

### Second Embodiment

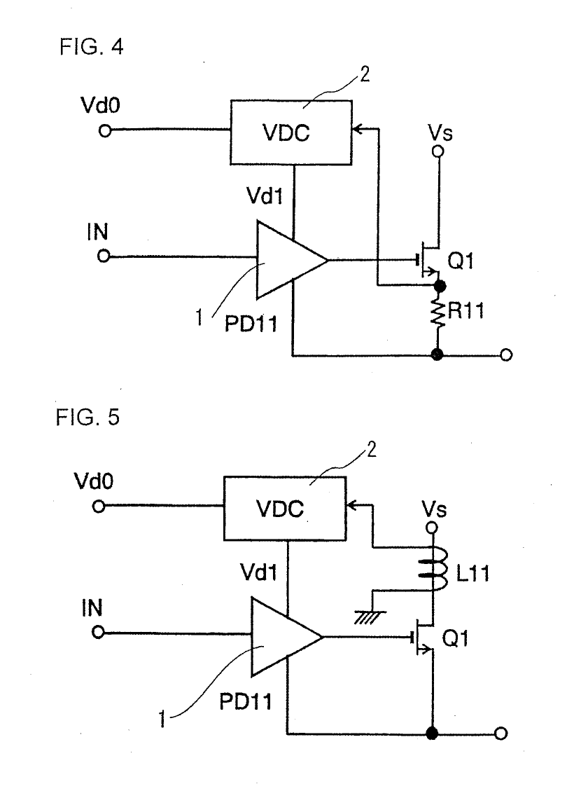

FIG. 4 shows a second embodiment of the sustain circuit of the plasma display device according to the present invention.

The sustain circuit of the plasma display device shown in FIG. 4 detects a sustain current passing through the output element Q1 in a resistance R11.

The drive voltage control circuit VDC2 controls the power supply voltage Vd1 to be supplied to the pre-drive circuit 1 (PD11) according to the voltage detected in the resistance R11.

The sustain circuit of the plasma display device shown in FIG. 4 heightens Vd1 when the sustain current passing through Q1 is large, and increases the amplitude of the drive pulse to be supplied to Q1. As a result of this, it is possible to reduce the conduction voltage of Q1.

The display percentage and the size of the sustain current are generally correlated, where the sustain current is large when the display percentage is large.

Therefore, it is possible, according to the configuration of this embodiment, to reduce conduction voltage of the output elements when the display percentage is large so as to secure the operation margin. When the display percentage is small and the sustain current is small, the power supply voltage Vd1 can be reduced and so the power consumption of the pre-drive circuit 1 can be decreased.

### Third Embodiment

FIG. 5 shows a third embodiment of the sustain circuit of the plasma display device according to the present invention.

The sustain circuit of the plasma display device shown in FIG. 5 detects a sustain current passing through the output element Q1 in a coil L11.

The drive voltage control circuit VDC2 controls the power supply voltage Vd1 to be supplied to the pre-drive circuit 1 (PD11) according to the voltage detected in the coil L11.

The circuit shown in FIG. 5 heightens Vd1 when the sustain current passing through Q1 is large, and increases the amplitude of the drive pulse supplied to Q1. As a result of this, it is possible to reduce the conduction voltage of Q1.

The display percentage and the size of the sustain circuit are generally correlated, where the sustain circuit is large when the display percentage is large.

Therefore, it is possible, according to this embodiment as with the first and second embodiments, to secure the operation margin by reducing conduction voltage of the output elements when the display percentage is large. When the display percentage is small and the sustain current is small, the power supply voltage Vd1 can be reduced and so the power consumption of the pre-drive circuit 1 can be decreased.

### Other Embodiments

The circuit shown in FIG. 5 may also use a current transformer instead of the coil L11 and connect Q1 to a primary side of the current transformer so as to detect the sustain current by utilizing the voltage generated on a secondary side of the current transformer.

In FIG. 6, a scan driver SD, a first Y sustain pulse generating circuit and a second Y sustain pulse generating circuit are configured by using different switches respectively.

On the other hand, it is possible, as a thinkable method, to generate scan pulses by using the first Y sustain pulse generating circuit and second Y sustain pulse generating circuit without using the scan driver SD.

As a concrete embodiment, it is a method wherein Q1 and Q2 of FIG. 1 are provided to each individual electrode, and Q1 and Q2 are turned on and off in a scan period so as to generate the scan pulses to be supplied to the Y electrodes.

In this case, sustain pulses are also generated by turning Q1 and Q2 on and off in a sustain period. It is possible to simplify circuit size by forming the scan pulses and sustain pulses with the same switch elements.

Even in the case of forming the scan pulses and sustain pulses with the same switch elements, it is possible to achieve the same effects as the aforementioned embodiment by applying the aforementioned embodiment and controlling the amplitude of the drive pulse supplied to Q1 and Q2.

Hereunder, configuration examples of the present invention will be described in additional statements.

### Additional Statement 1

A plasma display device including:

a display percentage detection circuit for detecting a display percentage of a screen to be displayed from an inputted video signal; and

a drive voltage control circuit 2 for controlling amplitude of a drive pulse supplied to output elements of a sustain circuit according to the display percentage.

### Additional Statement 2

The plasma display device according to the additional statement 1, characterized in that:

the drive voltage control circuit 2 is a power supply voltage control circuit for controlling power supply voltage of a pre-drive circuit which forms the drive pulse to be supplied to sustain output elements.

### Additional Statement 3

The plasma display device according to the additional statement 1, characterized in that:

the drive voltage control circuit increases the amplitude of the drive pulse when the detected display percentage is high.

### Additional Statement 4

The plasma display device according to the additional statement 2, characterized in that:

the drive voltage control circuit increases the power supply voltage of the pre-drive circuit when the detected display percentage is high.

### Additional Statement 5

A plasma display device including:

a sustain current detection circuit for detecting a sustain current to be supplied to a plasma display panel in a sustain period; and

a drive voltage control circuit for controlling amplitude of a drive pulse supplied to output elements of a sustain circuit according to an output signal of the sustain current detection circuit.

### Additional Statement 6

The plasma display device according to the additional statement 5, characterized in that:

the sustain current detection circuit is configured by using resistances.

### Additional Statement 7

The plasma display device according to the additional statement 5, characterized in that:

the sustain current detection circuit is configured by using coils.

### Additional Statement 8

The plasma display device according to the additional statement 7, characterized in that:

the sustain current detection circuit is configured by using a current detection transformer for detecting a current passing to the sustain output elements.

### Additional Statement 9

The plasma display device according to the additional statement 1, characterized in that:

the same output element drives both scan pulses to be supplied to a plasma display panel in a scan period and sustain pulses to be supplied to a plasma display panel in a sustain period.

### Additional Statement 10

The plasma display device according to the additional statement 5, characterized in that:

the same output element drives both scan pulses to be supplied to a plasma display panel in a scan period and sustain pulses to be supplied to a plasma display panel in a sustain period.

### Additional Statement 11

A plasma display device including:

a high-side output element for supplying a high-level voltage to a plasma display panel in a sustain period; and

a low-side output element for supplying a low-level voltage to the plasma display panel in the sustain period,

characterized in that amplitude of a drive pulse to be supplied to the high-side output element and the low-side output element is changed according to a display percentage of an image displayed on the plasma display panel.

### Additional Statement 12

The plasma display device according to the additional statement 11, characterized in that:

the amplitude of the drive pulse is increased when the display percentage is high.

### Additional Statement 13

A plasma display device including:

a high-side output element for supplying a high-level voltage to a plasma display panel in a sustain period; and

a low-side output element for supplying a low-level voltage to the plasma display panel in the sustain period,

characterized in that a sustain current to be supplied to the plasma display panel in the sustain period is detected, and amplitude of a drive pulse to be supplied to the high-side output element and the low-side output element is changed according to the sustain current.

### Additional Statement 14

The plasma display device according to the additional statement 13, characterized in that:

the amplitude of the drive pulse to be supplied to the high-side output element and the low-side output element is increased when the sustain current is large.

### Additional Statement 15

A plasma display device including:

a high-side output element for supplying a high-level voltage to a plasma display panel in a sustain period;

a low-side output element for supplying a low-level voltage to the plasma display panel in the sustain period;

a first power recovery switch for becoming on immediately before the low-side element becomes on and supplying a current to the plasma display panel via a coil; and

a second power recovery switch for becoming on immediately before the low-side element becomes on and supplying a current to the plasma display panel via a coil;

characterized in that amplitude of a drive pulse to be supplied to the high-side output element, the low-side output element, the first power recovery switch and the second power recovery switch is changed according to a display percentage of an image displayed on the plasma display panel.

### Additional Statement 16

The plasma display device according to the additional statement 15, characterized in that:

the amplitude of the drive pulse is increased when the display percentage is high.

### Additional Statement 17

A plasma display device including:

a high-side output element for supplying a high-level voltage to a plasma display panel in a sustain period;

a low-side output element for supplying a low-level voltage to the plasma display panel in the sustain period;

a first power recovery switch for becoming on immediately before the high-side element becomes on and supplying a current to the plasma display panel via a coil; and

a second power recovery switch for becoming on immediately before the low-side element becomes on and supplying a current to the plasma display panel via a coil;

characterized in that a sustain current to be supplied to the plasma display panel in the sustain period is detected, and amplitude of a drive pulse to be supplied to the high-side output element, the low-side output element, the first power recovery switch and the second power recovery switch is changed according to the sustain current.

### Additional Statement 18

The plasma display device according to the additional statement 17, characterized in that:

the amplitude of the drive pulse is increased when the sustain current is large.

### Additional Statement 19

The plasma display device according to the additional statements 2 and 4, characterized in that:

the power supply voltage control circuit is the circuit shown in FIG. 2 or FIG. 3.

### Additional Statement 20

The plasma display device according to the additional statements 5 and 6, characterized in that:

the sustain current detection circuit, pre-drive circuit and drive voltage control circuit are configured as the circuit shown in FIG. 4.

### Additional Statement 21

The plasma display device according to the additional statements 7 and 8, characterized in that:

the sustain current detection circuit, pre-drive circuit and drive voltage control circuit are configured as the circuit shown in FIG. 5.

1. A plasma display device having multiple first and second electrodes in parallel placed adjacently to each other and multiple third electrodes placed to intersect with the first and second electrodes and performing luminescent display by applying a sustained discharge pulse to the first and second electrodes, comprising:
display percentage detection means for detecting a display percentage of a screen to be displayed based on an inputted video signal; and
a drive circuit for generating the sustained discharge pulse, and characterized in that:
the drive circuit is configured by including: output stage elements of the sustained discharge pulse; a pre-drive portion for supplying a drive pulse which decides drive timing of the output stage elements; and a voltage control circuit for controlling an amplitude value of the drive pulse, and
the voltage control circuit controls the amplitude value of the drive pulse based on the display percentage.

2. The plasma display device according to claim 1, characterized in that the voltage control circuit is configured to control power supply voltage of the pre-drive portion based on the display percentage and thereby control the amplitude value of the drive pulse.

3. The plasma display device according to claim 1, characterized in that the voltage control circuit exerts control to increase the amplitude value of the drive pulse when the display percentage is high.

4. The plasma display device according to claim 2, characterized in that the voltage control circuit exerts control to increase a power supply voltage value of the pre-drive portion when the display percentage is high.

5. A plasma display device having multiple parallel first and second electrodes placed adjacently to each other and multiple third electrodes placed to intersect with the first and second electrodes and performing luminescent display by applying a sustained discharge pulse to the first and second electrodes, comprising:
a sustain current detection circuit for detecting a sustain current value on performing the luminescent display by the sustained discharge pulse; and
a drive circuit for generating the sustained discharge pulse, and characterized in that:
the drive circuit is configured by including: output stage elements of the sustained discharge pulse; a pre-drive portion for supplying a drive pulse which decides drive timing of the output stage elements; and a voltage control circuit for controlling an amplitude value of the drive pulse, and
the voltage control circuit controls the amplitude value of the drive pulse based on the sustain current value.

6. The plasma display device according to claim 5, characterized in that the sustain current detection circuit is configured by including resistances.

7. The plasma display device according to claim 5, characterized in that the sustain current detection circuit is configured by including coils.

8. The plasma display device according to claim 5, characterized in that the sustain current detection circuit is configured by including a current detection transformer for detecting a current passing to the output stage elements.
